(19) United States
(12) Patent Application Publication
(10) Pub. No.: US 2024/0373213 A1
(43) Pub. Date: Nov. 7, 2024

(54) TRANSMITTING STATION AND RECEIVING STATION

(71) Applicant: NIPPON TELEGRAPH AND TELEPHONE CORPORATION, Tokyo (JP)

(72) Inventors: Akira KISHIDA, Musashino-shi, Tokyo (JP); Kengo NAGATA, Musashino-shi, Tokyo (JP); Shoko SHINOHARA, Musashino-shi, Tokyo (JP); Hanae OTANI, Musashino-shi, Tokyo (JP); Yusuke ASAI, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/686,884

(22) PCT Filed: Aug. 30, 2021
(86) PCT No.: PCT/JP2021/031719

§ 371 Date: Feb. 27, 2024

(51) Int. Cl. H04W 12/03; H04L 1/00; H04W 28/06

(52) U.S. Cl. CPC H04W 12/03; H04L 1/0061; H04W 28/065

(57) ABSTRACT

A transmitting station includes a fragmentation unit, a packet number allocation unit, an encryption unit, a wireless signal processing unit, and a retransmission control unit. The fragmentation unit divides data into fragments. The packet number allocation unit allocates a first packet number to the fragments. The encryption unit encrypts the fragments on the basis of the first packet number. The wireless signal processing unit transmits the fragments encrypted as a wireless signal to a receiving station. When retransmitting the data, the retransmission control unit instructs the packet number allocation unit to reset the first packet number to an initial value, requests the receiving station to reset a second packet number managed by the receiving station to an initial value for decryption of the fragments encrypted, and instructs the fragmentation unit to reconfigure an unsuccessfully transmitted fragment.

### CROSS-REFERENCE TO RELATED APPLICATION

This application is a national stage application, pursuant to 35 U.S.C. § 371, of International Patent Application No. PCT/JP2021/031719, filed Aug. 30, 2021, the entire contents of which is incorporated herein by reference.

### TECHNICAL FIELD

Embodiments relate to a transmitting station and a receiving station.

### BACKGROUND ART

A wireless local area network (LAN) is known as a wireless system between a transmitting station that transmits a wireless signal and a receiving station that receives the wireless signal, such as an access point and a terminal. In the wireless LAN, packets are encrypted. This encryption is performed in accordance with, for example, an advanced encryption standard (AES) based method called a counter mode with CBC-MAC protocol (CCMP).

### CITATION LIST

### Non Patent Literature

Non Patent Literature 1: IEEE Std 802.11-2016, “12.5.3 CTR with CBC-MAC protocol (CCMP)”, 7 Dec. 2016

### SUMMARY OF INVENTION

### Technical Problem

It is considered to redo fragmentation to reconfigure a packet at the time of retransmission or the like. Here, since the fragmentation is performed again, encryption and decryption may not be appropriately performed.

An embodiment provides a transmitting station and a receiving station in which encryption and decryption are appropriately performed even in a case where the fragmentation is redone.

### Solution to Problem

A transmitting station of one aspect includes a fragmentation unit, a packet number allocation unit, an encryption unit, a wireless signal processing unit, and a retransmission control unit. The fragmentation unit divides data into fragments. The packet number allocation unit allocates a first packet number to the fragments. The encryption unit encrypts the fragments on the basis of the first packet number. The wireless signal processing unit transmits the fragments encrypted as a wireless signal to a receiving station. The retransmission control unit controls retransmission of the data on the basis of a response from the receiving station. When retransmitting the data, the retransmission control unit instructs the packet number allocation unit to reset the first packet number to an initial value, requests the receiving station to reset a second packet number managed by the receiving station to an initial value for decryption of the fragments encrypted, and instructs the fragmentation unit to reconfigure an unsuccessfully transmitted fragment.

### Advantageous Effects of Invention

According to the embodiment, a transmitting station and a receiving station are provided in which encryption and decryption are appropriately performed even in a case where fragmentation is redone.

### BRIEF DESCRIPTION OF DRAWINGS

FIG. 1 is a diagram illustrating an example of a configuration of a wireless system of an embodiment.

FIG. 2 is a diagram illustrating a specific example of a format of a MAC frame.

FIG. 3 is a diagram illustrating an example of a configuration of an access point.

FIG. 4 is a diagram illustrating an example of a functional configuration of the access point.

FIG. 5 is a diagram illustrating an example of a configuration of a terminal.

FIG. 6 is a diagram illustrating an example of a functional configuration of the terminal.

FIG. 7 is a diagram illustrating an example of a functional configuration of a MAC frame processing unit.

FIG. 8 is a diagram illustrating an example of a configuration of an encryption unit.

FIG. 9 is a diagram illustrating a specific example of AAD.

FIG. 10 is a diagram illustrating a specific example of a Nonce.

FIG. 11 is a diagram illustrating a specific example of a Nonce flag.

FIG. 12 is a diagram illustrating a specific example of a frame format of an encrypted MPDU.

FIG. 13 is a diagram illustrating an example of a configuration of a decryption unit.

FIG. 14 is a flowchart illustrating operation of a retransmission control unit in a transmitting station.

FIG. 15A is a diagram illustrating an example of a configuration of an A-MPDU in a wireless frame of a wireless signal transmitted from the transmitting station.

FIG. 15B is a diagram illustrating an example of a reception status in a receiving station in a case where the wireless signal illustrated in FIG. 15A is transmitted.

FIG. 15C is a diagram illustrating an example of a configuration of the A-MPDU in a retransmission frame of the wireless signal transmitted from the transmitting station.

FIG. 15D is a diagram illustrating an example of the reception status in the receiving station in a case where the wireless signal in FIG. 15C is transmitted.

### DESCRIPTION OF EMBODIMENTS

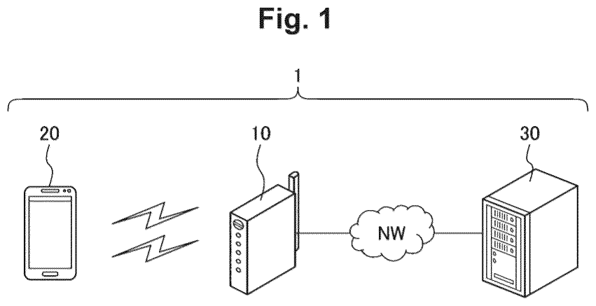

Hereinafter, an embodiment will be described with reference to the drawings. FIG. 1 is a diagram illustrating an example of a configuration of a wireless system 1 of the embodiment. As illustrated in FIG. 1, the wireless system 1 includes, for example, an access point 10, a terminal 20, and a server 30.

The access point 10 is connected to a network NW and used as an access point (AP) of a wireless LAN. For example, the access point 10 can wirelessly distribute data received from the network NW to the terminal 20. In addition, the access point 10 may be connected to the terminal 20 by using one type of band or a plurality of types of bands. Communication between the access point 10 and the terminal 20 is based on, for example, the IEEE 802.11 standard. Here, communication based on the IEEE 802.11 standard will be described as an example, but the embodiment is not limited thereto.

The terminal 20 is a wireless terminal such as a smartphone or a tablet PC. The terminal 20 can transmit and receive data to and from the server 30 on the network NW via the access point 10 wirelessly connected. The terminal 20 may be another electronic device such as a desktop computer or a laptop computer. The terminal 20 only needs to be able to communicate with at least the access point 10.

The server 30 can hold various types of information, and holds, for example, data of content for the terminal 20. The server 30 is connected to the network NW by wire, for example, and is configured to be able to communicate with the access point 10 via the network NW. Note that, the server 30 only needs to be able to communicate with at least the access point 10. That is, communication between the access point 10 and the server 30 may be wired or wireless.

In the wireless system 1 according to the embodiment, wireless communication between the access point 10 and the terminal 20 is compliant with the IEEE 802.11 standard. In the IEEE 802.11 standard, the MAC sublayers of the first layer and the second layer of the open systems interconnection (OSI) reference model are specified. In the OSI reference model, a communication function is divided into seven layers (the first layer: a physical layer, the second layer: a data link layer, the third layer: a network layer, the fourth layer: a transport layer, the fifth layer: a session layer, the sixth layer: a presentation layer, the seventh layer: an application layer). In addition, the data link layer includes, for example, a logical link control (LLC) layer and a media access control (MAC) layer. In the LLC layer, for example, a destination service access point (DSAP) header, a source service access point (SSAP) header, or the like is added to data input from an application of an upper layer, whereby an LLC packet is formed. In the MAC layer, for example, a MAC frame is formed by adding a MAC header to an LLC packet. In the present description, processing for the MAC sublayer of the second layer and the first layer defined by the IEEE 802.11 standard will be mainly described, and description of processing for other layers will be omitted.

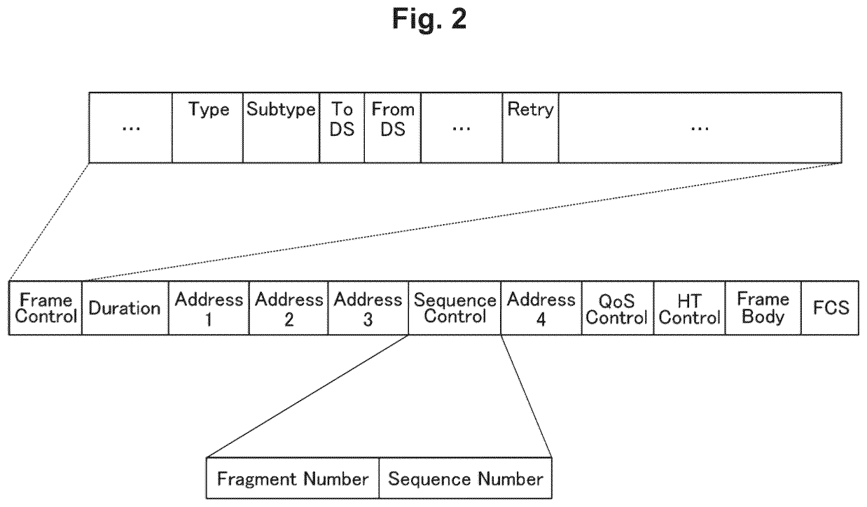

FIG. 2 is a diagram illustrating a specific example of a format of a MAC frame used for communication between the access point 10 and the terminal 20 in the wireless system 1 according to the embodiment. As illustrated in FIG. 2, the MAC frame includes, for example, a Frame Control field, a Duration field, an Address 1 field, an Address 2 field, an Address 3 field, a Sequence Control field, an Address 4 field, a Qos Control field, an HT Control field, a Frame Body field, and a Frame Check Sequence (FCS) field. These fields may or may not be included depending on a type of wireless frame.

The Frame Control field to the HT Control field correspond to the MAC header. The Frame Body field corresponds to a MAC payload. The FCS field stores an error detection code of the MAC header and the Frame Body field. The FCS field is used to determine the presence or absence of an error in the MAC frame.

The Frame Control field includes various types of control information, for example, a Type value, a Subtype value, a To DS (Distribution System) value, a From DS value, and a Retry value. The Type value indicates whether the MAC frame is a management frame, a control frame, or a data frame. The Subtype value is used in combination with the Type value to indicate a frame type of the MAC frame. For example, “00/1000 (Type value/Subtype value)” indicates that the MAC frame is a beacon. In addition, “00/0100 (Type value/Subtype value)” indicates that the MAC frame is a probe request. In addition, “00/0101 (Type value/Subtype value)” indicates that the MAC frame is a probe response. The To DS value and the From DS value have different meanings depending on a combination thereof. For example, the To DS value “0” when the MAC frame is the data frame indicates that the receiving station is a terminal, and “1” indicates that the receiving station is an access point. In addition, the From DS value “0” when the MAC frame is the data frame indicates that the transmitting station is a terminal, and “1” indicates that the transmitting station is an access point. On the other hand, the To DS value and the From DS value when the MAC frame is the management frame or the control frame are fixed to, for example, “0”. The Retry value indicates whether or not the MAC frame is a retransmission frame. For example, the Retry value “0” indicates that the MAC frame is not a retransmission frame, that is, is an original MAC frame. On the other hand, the Retry value “1” indicates that the MAC frame is a retransmission frame.

The Duration field indicates a scheduled period of use of a wireless line. The Address field indicates a BSSID, a transmission source MAC address, a destination MAC address, an address of a transmitter terminal, an address of a receiver terminal, and the like. The number of Address fields used varies with the frame type. The Sequence Control field indicates a sequence number and a fragment number. The QoS Control field is used for a Quality of Service (QOS) function in the MAC frame. The Qos Control field may include a traffic type (TID) subfield. The HT Control field is a Control field for a high throughput function. The Frame Body field includes information depending on the frame type. For example, transmission data is stored in the Frame Body field in a case where the frame type is the data frame.

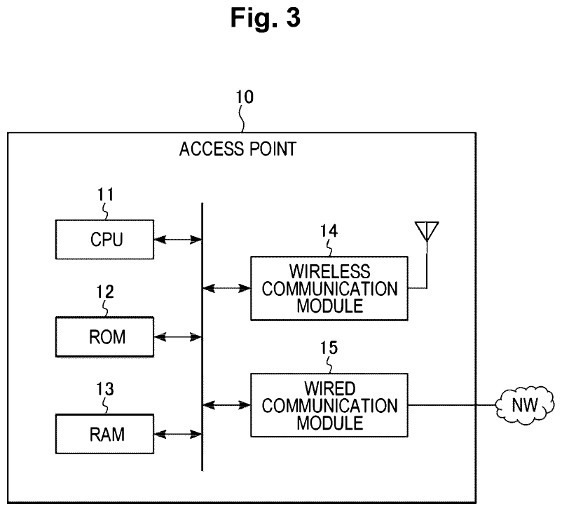

FIG. 3 is a diagram illustrating an example of a configuration of the access point 10. As illustrated in FIG. 3, the access point 10 includes, for example, a central processing unit (CPU) 11, a read only memory (ROM) 12, a random access memory (RAM) 13, a wireless communication module 14, and a wired communication module 15.

The CPU 11 is a circuit capable of executing various programs, and controls overall operation of the access point 10. The ROM 12 is a nonvolatile semiconductor memory, and holds a program, control data, and the like for controlling the access point 10. The RAM 13 is, for example, a volatile semiconductor memory, and is used as a working area for the CPU 11. The wireless communication module 14 is a circuit used for transmission and reception of data by a wireless signal, and is connected to an antenna. The wired communication module 15 is a circuit used for transmission and reception of data by a wired signal, and is connected to the network NW.

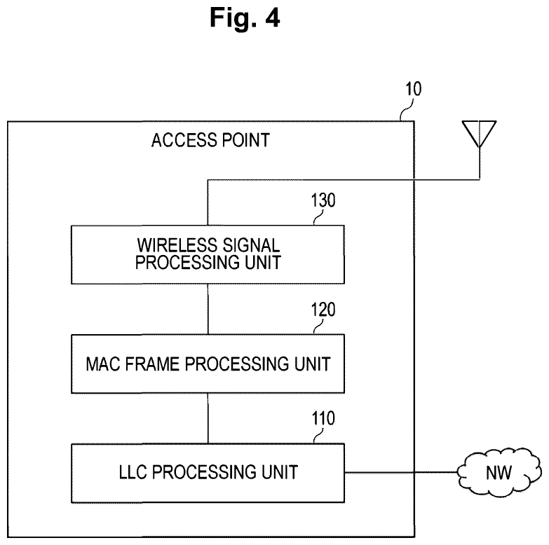

FIG. 4 is a diagram illustrating an example of a functional configuration of the access point 10. As illustrated in FIG. 4, the access point 10 includes, for example, an LLC processing unit 110, a MAC frame processing unit 120, and a wireless signal processing unit 130. The LLC processing unit 110, the MAC frame processing unit 120, and the wireless signal processing unit 130 are implemented by the wireless communication module 14 or a combination of the CPU 11 and the wireless communication module 14.

The LLC processing unit 110 can execute LLC layer processing on input data. For example, the LLC processing unit 110 generates an LLC packet by adding a destination service access point (DSAP) header, a source service access point (SSAP) header, and the like to data input from the server 30 via the network NW. Then, the LLC processing unit 110 outputs the LLC packet to the MAC frame processing unit 120. In addition, the LLC processing unit 110 extracts data from a MAC frame input from the MAC frame processing unit 120. Then, the LLC processing unit 110 transmits the data to the server 30 via the network NW.

The MAC frame processing unit 120 executes MAC layer processing on an LLC packet input from the LLC processing unit 110 to generate a MAC frame. Then, the MAC frame processing unit 120 outputs the MAC frame to the wireless signal processing unit 130. In addition, the MAC frame processing unit 120 executes MAC layer processing on a MAC frame input from the wireless signal processing unit 130 to restore an LLC packet. Then, the MAC frame processing unit 120 outputs the LLC packet to the LLC processing unit 110. Details of the MAC frame processing unit 120 will be described later.

The wireless signal processing unit 130 can execute physical layer processing. For example, when receiving a MAC frame from the MAC frame processing unit 120, the wireless signal processing unit 130 generates a PHY frame by adding a physical (PHY) header to the MAC frame. Then, the wireless signal processing unit 130 performs a predetermined modulation operation on the PHY frame to convert the PHY frame into a wireless signal, and transmits the wireless signal via the antenna. The predetermined modulation operation includes convolutional coding, interleaving, subcarrier modulation, inverse fast Fourier transform (IFFT), orthogonal frequency division multiplexing (OFDM) modulation, and frequency transform, for example. In addition, when receiving a wireless signal via the antenna, the wireless signal processing unit 130 performs a predetermined demodulation operation on the received wireless signal to restore a PHY frame. The predetermined demodulation operation includes frequency transform, OFDM demodulation, fast Fourier transform (FFT), subcarrier demodulation, deinterleaving, and Viterbi decoding, for example. Then, the wireless signal processing unit 130 extracts the MAC frame from the PHY frame, and outputs the extracted MAC frame to the MAC frame processing unit 120.

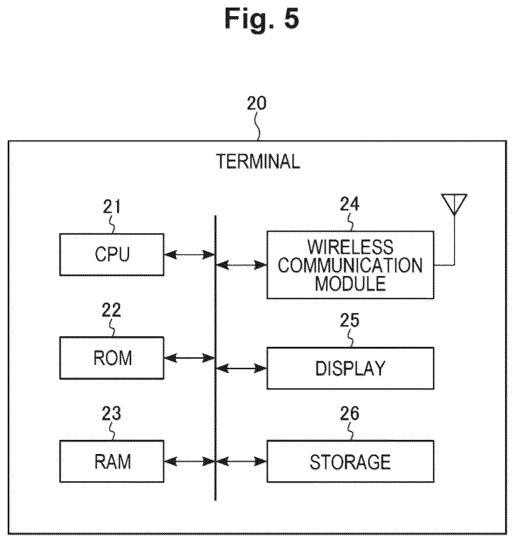

FIG. 5 is a diagram illustrating an example of a configuration of the terminal 20. As illustrated in FIG. 5, the terminal 20 includes, for example, a CPU 21, a ROM 22, a RAM 23, a wireless communication module 24, a display 25, and a storage 26.

The CPU 21 is a circuit capable of executing various programs, and controls overall operation of the terminal 20. The ROM 22 is a nonvolatile semiconductor memory, and holds a program, control data, and the like for controlling the terminal 20. The RAM 23 is, for example, a volatile semiconductor memory, and is used as a working area for the CPU 21. The wireless communication module 24 is a circuit used for transmission and reception of data by a wireless signal, and is connected to an antenna. The display 25 displays a graphical user interface (GUI) corresponding to application software, or the like. The display 25 may have a function as an input interface of the terminal 20. The storage 26 is a nonvolatile storage device, and holds system software of the terminal 20, and the like.

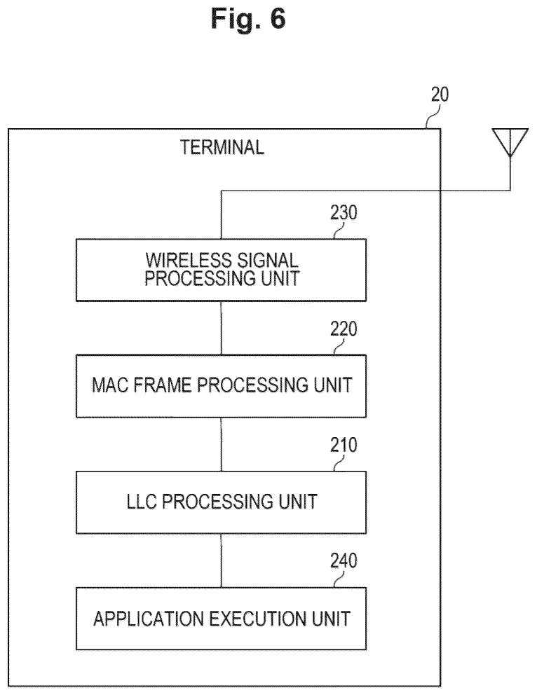

FIG. 6 is a diagram illustrating an example of a functional configuration of the terminal 20. As illustrated in FIG. 6, the terminal 20 includes, for example, an LLC processing unit 210, a MAC frame processing unit 220, a wireless signal processing unit 230, and an application execution unit 240. The LLC processing unit 210, the MAC frame processing unit 220, and the wireless signal processing unit 230 are implemented by the wireless communication module 24 or a combination of the CPU 21 and the wireless communication module 24. In addition, the application execution unit 240 is implemented by the CPU 21.

The LLC processing unit 210 generates an LLC packet by adding a DSAP header, an SSAP header, and the like to data input from an upper level such as an application. Then, the LLC processing unit 210 outputs the LLC packet to the MAC frame processing unit 220. In addition, the LLC processing unit 210 extracts data from a MAC frame input from the MAC frame processing unit 220. Then, the LLC processing unit 210 outputs the data to the upper layer.

The MAC frame processing unit 220 executes MAC layer processing on an LLC packet input from the LLC processing unit 210 to generate a MAC frame. Then, the MAC frame processing unit 220 outputs the MAC frame to the wireless signal processing unit 230. In addition, the MAC frame processing unit 220 executes MAC layer processing on a MAC frame input from the wireless signal processing unit 230 to restore an LLC packet. Then, the MAC frame processing unit 220 outputs the LLC packet to the LLC processing unit 210. Details of the MAC frame processing unit 220 will be described later.

The wireless signal processing unit 230 can execute physical layer processing. For example, when receiving a MAC frame from the MAC frame processing unit 220, the wireless signal processing unit 230 generates a PHY frame by adding a PHY header to the MAC frame. Then, the wireless signal processing unit 230 performs a predetermined modulation operation on the PHY frame to convert the PHY frame into a wireless signal, and transmits the wireless signal via the antenna. In addition, when receiving a wireless signal via the antenna, the wireless signal processing unit 230 performs a predetermined demodulation operation on the received wireless signal to restore a PHY frame. Then, the wireless signal processing unit 230 extracts the MAC frame from the PHY frame, and outputs the extracted MAC frame to the MAC frame processing unit 220.

The application execution unit 240 executes an application that can use data input from the LLC processing unit 210. For example, the application execution unit 240 can display application information on the display 25. In addition, the application execution unit 240 can operate on the basis of operation of the input interface.

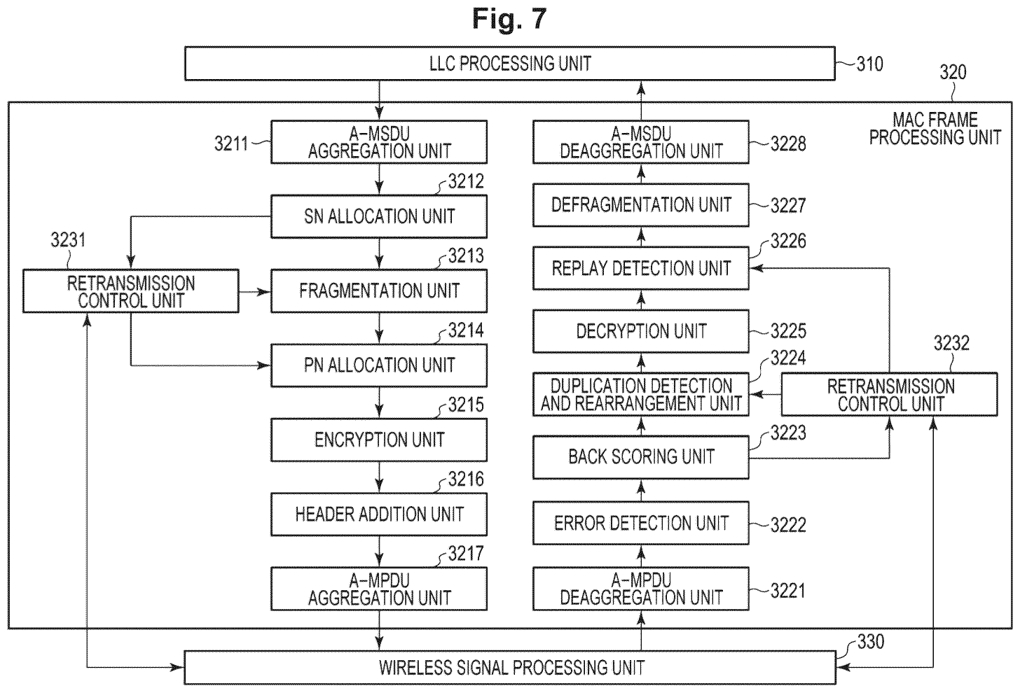

Next, the MAC frame processing unit will be further described. Here, the MAC frame processing unit 120 of the access point 10 and the MAC frame processing unit 220 of the terminal 20 may have the same configuration. Thus, in the following, without distinguishing the MAC frame processing unit 120 and the MAC frame processing unit 220 from each other and they are set to be referred to as a MAC frame processing unit 320, a configuration thereof will be described. FIG. 7 is a diagram illustrating an example of a functional configuration of the MAC frame processing unit 320. Here, in FIG. 7, the LLC processing unit 110 and the LLC processing unit 210 are set as an LLC processing unit 310, and the wireless signal processing unit 130 and the wireless signal processing unit 230 are set as a wireless signal processing unit 330. In addition, in the following, as necessary, between the access point 10 and the terminal 20, a station on a side of transmitting data is a transmitting station, and a station on a side of receiving data is a receiving station.

The MAC frame processing unit 320 includes an element that performs MAC layer processing for transmission, an element that performs MAC layer processing for reception, and an element that performs retransmission control. The element that performs MAC layer processing for transmission includes an A-MSDU aggregation unit 3211, a sequence number (SN) allocation unit 3212, a fragmentation unit 3213, a packet number (PN) allocation unit 3214, an encryption unit 3215, a header addition unit 3216, and an A-MPDU aggregation unit 3217. The element that performs MAC layer processing for reception includes an A-MPDU deaggregation unit 3221, an error detection unit 3222, a block ACK (BACK) scoring unit 3223, a duplication detection and rearrangement unit 3224, a decryption unit 3225, a replay detection unit 3226, a defragmentation unit 3227, and an A-MSDU deaggregation unit 3228. The element that performs retransmission control includes a retransmission control unit 3231 and a retransmission control unit 3232.

The A-MSDU aggregation unit 3211 combines data of units of a plurality of MAC Service Data Units (MSDUs) input from the LLC processing unit 310 to create one Aggregated-MSDU (A-MSDU). The A-MSDU aggregation unit 3211 can combine data in units of MSDUs with the same destination and the same Traffic Identifier (TID) into an A-MSDU.

The SN allocation unit 3212 allocates one sequence number (SN) to one A-MSDU. In the SN allocation unit 3212, the sequence number is used to specify data for which reception has succeeded. In addition, the SN allocation unit 3212 has a buffer for holding an A-MSDU. The A-MSDU held in the buffer can be used for reconfiguration of fragments at the time of retransmission.

The fragmentation unit 3213 divides each A-MSDU into fragments. The fragmentation unit 3213 allocates a fragment number (FN) to each fragment. Data constituting each fragment corresponds to an MPDU described later. The fragment number is allocated to be closed for each sequence number. That is, for fragments having the same sequence number, fragment numbers are allocated in sequential numbers in order from the beginning, and for fragments having different sequence numbers, fragment numbers are allocated in sequential numbers in order from the beginning again. The fragment number is used together with the sequence number to specify data for which reception has succeeded.

The PN allocation unit 3214 allocates a packet number (PN) to each fragment. The packet number is, for example, a 48-bit number, and in principle, is incremented by 1 every time a fragment is input. On the other hand, in a case where a temporary key (TK) used in the encryption unit 3215 is reset or when an instruction to reset the packet number is received from the retransmission control unit 3231, the PN allocation unit 3214 resets the packet number. The packet number is one of parameters used as a seed for encryption by the encryption unit 3215.

The encryption unit 3215 encrypts each fragment. The encryption by the encryption unit 3215 is performed in accordance with, for example, a Counter-mode with CBC-MAC protocol (CCMP) method. The encryption unit 3215 will be described in detail later.

The header addition unit 3216 adds a MAC header and an FCS to encrypted data output from the encryption unit 3215 to generate an encrypted MAC Protocol Data Unit (MPDU).

The A-MPDU aggregation unit 3217 generates one A-MPDU by combining a plurality of MPDUs. Then, the A-MPDU aggregation unit 3217 outputs the generated A-MPDU to the wireless signal processing unit 330.

The A-MPDU deaggregation unit 3221 performs A-MPDU deaggregation on a MAC frame input from the wireless signal processing unit 330. The A-MPDU deaggregation is processing of deaggregating (dividing) the A-MPDU in units of MPDUs.

The error detection unit 3222 performs error detection on each MPDU. The error detection is performed on the basis of an error detection code, for example, a CRC.

The BACK scoring unit 3223 updates a scoring board depending on an error detection result by the error detection unit 3222. The scoring board represents a reception status of each MPDU. When the MPDU is received without errors, the BACK scoring unit 3223 records, for example, 1 at a place of a corresponding sequence number and fragment number of the scoring board. In addition, when the MPDU is not received without errors, the BACK scoring unit 3223 records, for example, 0 at the place of the corresponding sequence number and fragment number on the scoring board.

The duplication detection and rearrangement unit 3224 performs duplication detection of the MPDU in accordance with the sequence number and the fragment number. Then, the duplication detection and rearrangement unit 3224 discards MPDUs whose sequence numbers and fragment numbers are duplicated, and holds MPDUs whose sequence numbers and fragment numbers are not duplicated in the buffer. In addition, the duplication detection and rearrangement unit 3224 rearranges the MPDUs held in the buffer in the order of the sequence number and the fragment number, and outputs the MPDUs arranged in order to the decryption unit 3225. In addition, the duplication detection and rearrangement unit 3224 clears the buffer in accordance with a request for clearing the buffer from the retransmission control unit 3232.

The decryption unit 3225 decrypts the MPDU encrypted. Decryption by the decryption unit 3225 is performed in accordance with a method corresponding to the encryption by the encryption unit 3215. The decryption unit 3225 will be described in detail later.

The replay detection unit 3226 performs replay detection. For example, the replay detection unit 3226 compares a packet number input from the decryption unit 3225 together with an MPDU with a packet number managed by the replay detection unit 3226 itself, and outputs the input MPDU as it is if the input packet number is a sequential number and is not less than or equal to the packet number managed by the replay detection unit 3226 itself. On the other hand, if the input packet number is not a sequential number or is less than or equal to the packet number managed by the replay detection unit 3226 itself, the replay detection unit 3226 discards the input MPDU. The packet number managed by the replay detection unit 3226 is incremented by 1 for each decryption. On the other hand, when an instruction to reset the packet number is received from the retransmission control unit 3232, the replay detection unit 3226 resets the managed packet number.

The defragmentation unit 3227 restores an A-MSDU by combining the MPDUs divided in units of fragments output from the replay detection unit 3226.

The A-MSDU deaggregation unit 3228 performs processing of dividing the restored A-MSDU in units of MSDUs. Each of the divided MSDUs is input to the LLC processing unit 310.

The retransmission control unit 3231 is a retransmission control unit on a data transmission side. After completing transmission of data, the retransmission control unit 3231 sends out a block ACK request (BAR) to the receiving station via the wireless signal processing unit 330. Then, the retransmission control unit 3231 determines whether or not there is an MPDU that requires retransmission by a BACK received from the receiving station. Then, when there is an MPDU that requires retransmission, the A-MSDU held in the SN allocation unit 3212 is copied and input to the fragmentation unit 3213, and the fragmentation unit 3213 is instructed to perform reconfiguration of fragments corresponding to the MPDU that requires retransmission. In addition, in a case where an instruction for reconfiguration of fragments, the retransmission control unit 3231 instructs the PN allocation unit 3214 to reset the packet number to be allocated. Further, the retransmission control unit 3231 sends out, via the wireless signal processing unit 330, a request for resetting and duplication detection of the packet number managed by the replay detection unit 3226 of the receiving station and clearing the buffer of the duplication detection and rearrangement unit 3224.

The retransmission control unit 3232 is a retransmission control unit on a data reception side. In a case where the BAR is received, the retransmission control unit 3232 generates a BACK by referring to the scoring board managed by the BACK scoring unit 3223. Then, the retransmission control unit 3232 sends out the BACK to the transmitting station via the wireless signal processing unit 330. In addition, in response to a request for resetting the packet number and clearing the buffer from the transmitting station, the retransmission control unit 3232 gives an instruction to reset the packet number managed by the replay detection unit 3226 and gives an instruction to clear the buffer of the duplication detection and rearrangement unit 3224.

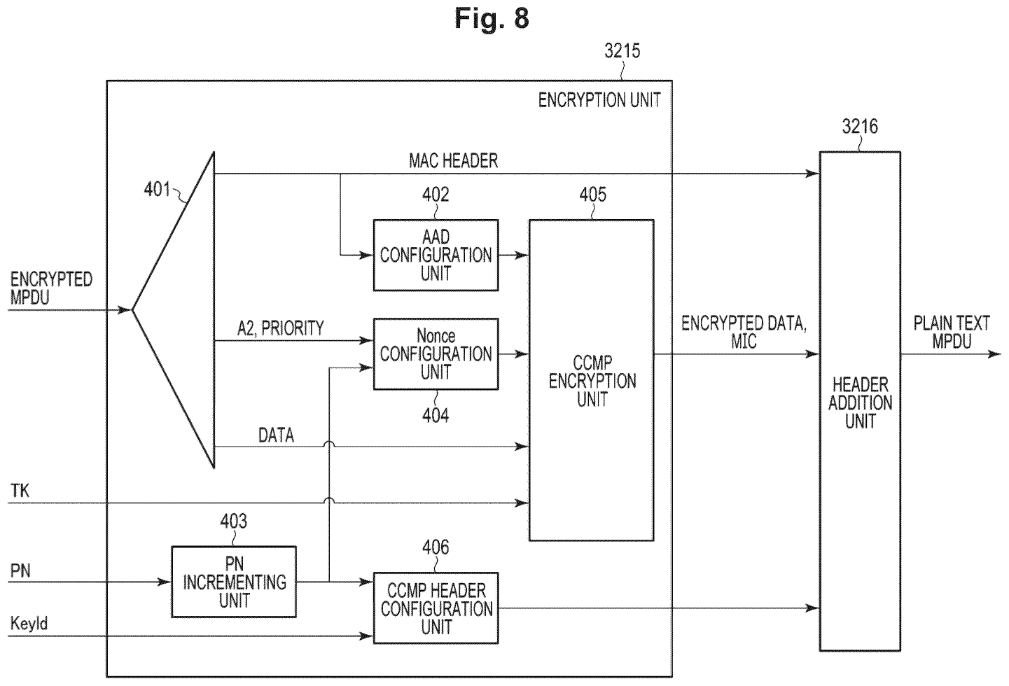

FIG. 8 is a diagram illustrating an example of a configuration of the encryption unit 3215. Here, the encryption unit 3215 in FIG. 8 is a configuration example of a CCMP method encryption unit. The encryption unit 3215 does not necessarily need to be the CCMP method encryption unit.

The encryption unit 3215 in the example of FIG. 8 includes a receiving unit 401, an additional authentication data (AAD) configuration unit 402, a PN incrementing unit 403, a Nonce configuration unit 404, a CCMP encryption unit 405, and a CCMP header configuration unit 406.

The receiving unit 401 receives a fragment as a plain MPDU and a MAC header from the PN allocation unit 3214. Then, the receiving unit 401 outputs the MAC header to the AAD configuration unit 402 and the MAC header addition unit 3216. In addition, the receiving unit 401 extracts information necessary for encryption from the received plain MPDU, and outputs the extracted information to the Nonce configuration unit 404 and the CCMP encryption unit 405. The receiving unit 401 outputs a value of the Address 2 field and a value of priority of the MPDU to the Nonce configuration unit 404. The value of priority is determined by, for example, the TID. In addition, the receiving unit 401 outputs fragment data to the CCMP encryption unit 405.

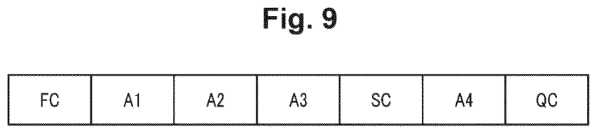

The AAD configuration unit 402 configures AAD from the MAC header. FIG. 9 is a diagram illustrating a specific example of the AAD. The AAD can include an MPDU frame control (FC) field, an address 1 (A1) field, an address 2 (A2) field, an address 3 (A3) field, a sequence control (SC) field, an address 4 (A4) field, and a Qos control (QC) field. In a case where the A4 field is omitted in the MAC header, the A4 field is also omitted from the AAD.

The PN incrementing unit 403 increments a packet number input from the PN allocation unit 3214. Then, the PN incrementing unit 403 outputs the packet number to the Nonce configuration unit 404 and the CCMP header configuration unit 406.

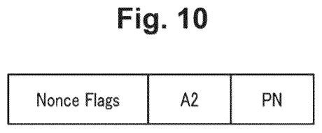

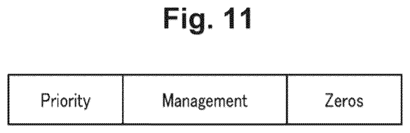

The Nonce configuration unit 404 configures a Nonce on the basis of the value of the Address 2 field, the value of priority of the MPDU, and the packet number. FIG. 10 is a diagram illustrating a specific example of the Nonce. The Nonce includes a Nonce flag, an A2 field, and a PN field. In addition, FIG. 11 is a diagram illustrating a specific example of the Nonce flag. As illustrated in FIG. 11, the Nonce flag includes a priority subfield, a management subfield, and a zero part.

The CCMP encryption unit 405 performs encryption of the fragment data with Counter-mode with CBC-MAC (CCM) based on 128-bit Advanced Encryption Standard (AES). The encryption of the data is performed by block encryption by an exclusive OR (XOR) operation of a counter created by using the AAD, the Nonce, and a temporary key (TK) and the data. Here, the TK is changed for each session. In addition, the CCMP encryption unit 405 generates a Message Integrity Code (MIC) for integrity check together with the encryption of the data. Then, the CCMP encryption unit 405 outputs the encrypted data and the MIC to the header addition unit 3216.

The CCMP header configuration unit 406 configures a CCMP header including information necessary for decryption on the basis of the packet number input from the PN incrementing unit 403, and a key ID. The key ID is an ID for designating the TK.

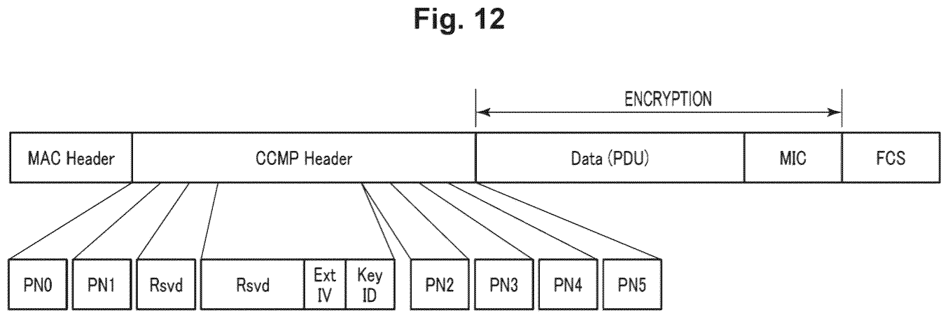

The header addition unit 3216 adds the MAC header and the FCS to the encrypted data, the MIC, and the CCMP header to configure an encrypted MPDU. FIG. 12 is a diagram illustrating a specific example of a frame format of the encrypted MPDU. As illustrated in FIG. 12, the CCMP header includes a PN0 subfield to a PN5 subfield, a key ID subfield, and an extended IV (Ext IV) subfield. The PN0 subfield to the PN5 subfield each stores a 48-bit packet number by 1 oct. For example, the PN0 subfield stores a value of the least significant 8 bits of the packet number. In addition, the PN5 subfield stores a value of the most significant 8 bits of the packet number. The Key ID subfield stores a key ID. A value of the Ext IV subfield is typically fixed at “1”.

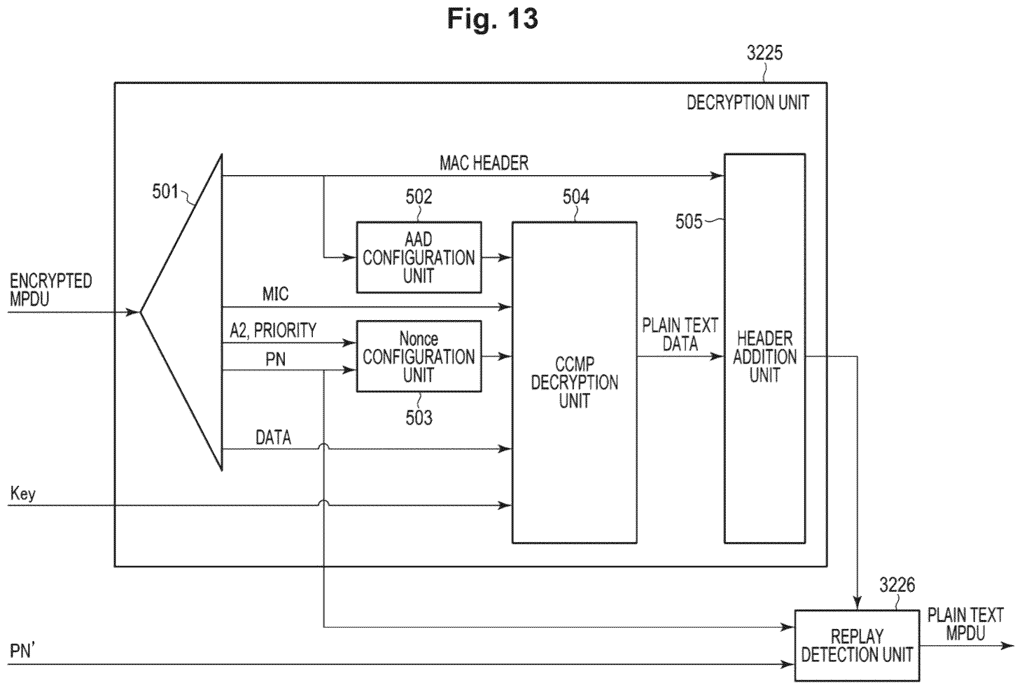

FIG. 13 is a diagram illustrating an example of a configuration of the decryption unit 3225. Here, the decryption unit 3225 in FIG. 13 is a configuration example of a CCMP method decryption unit. The decryption unit 3225 only needs to correspond to the encryption unit 3215. In addition, a part of the decryption unit 3225 may be configured as an element common to the encryption unit 3215.

The decryption unit 3225 in the example of FIG. 13 includes a receiving unit 501, an AAD configuration unit 502, a Nonce configuration unit 503, a CCMP decryption unit 504, and a header addition unit 505.

The receiving unit 501 receives an encrypted MPDU from the duplication detection and rearrangement unit 3224. Then, the receiving unit 501 outputs a MAC header to the AAD configuration unit 502 and the header addition unit 505. In addition, the receiving unit 501 extracts information necessary for decryption from the encrypted MPDU, and outputs the extracted information to the Nonce configuration unit 503 and the CCMP decryption unit 504. The receiving unit 501 outputs the value of the Address 2 field, the value of priority of the MPDU, and the packet number to the Nonce configuration unit 503. In addition, the receiving unit 501 outputs encrypted fragment data to the CCMP decryption unit 504.

The AAD configuration unit 502 configures AAD from the MAC header, similarly to the AAD configuration unit 402.

Similarly to the Nonce configuration unit 404, the Nonce configuration unit 503 configures a Nonce on the basis of the value of the Address 2 field extracted from the CCMP header, the value of priority of the MPDU, and the packet number.

The CCMP decryption unit 504 performs decryption of the fragment data by CCM based on 128-bit AES. The decryption of the data is performed by using the AAD, the Nonce, a decryption key specified by a key ID extracted from the CCMP header, and an MIC. Then, the CCMP decryption unit 504 outputs decrypted plain fragment data to the header addition unit 505.

The header addition unit 505 adds the MAC header to the plain fragment data to configure a plain MPDU. Then, the header addition unit 505 outputs the plain MPDU to the replay detection unit 3226.

The replay detection unit 3226 compares a packet number PN extracted from the CCMP header with a packet number PN′ managed by the replay detection unit 3226 itself. The PN′ corresponds to the packet number allocated by the PN allocation unit 3214, and is incremented for each decryption. If the packet number PN is a sequential number and is not less than or equal to the packet number PN′, the replay detection unit 3226 outputs the plain MPDU input from the header addition unit 505 as it is to the defragmentation unit 3227. On the other hand, if the packet number PN is not a sequential number or is less than or equal to the packet number PN′, the replay detection unit 3226 discards the plain MPDU input from the header addition unit 505.

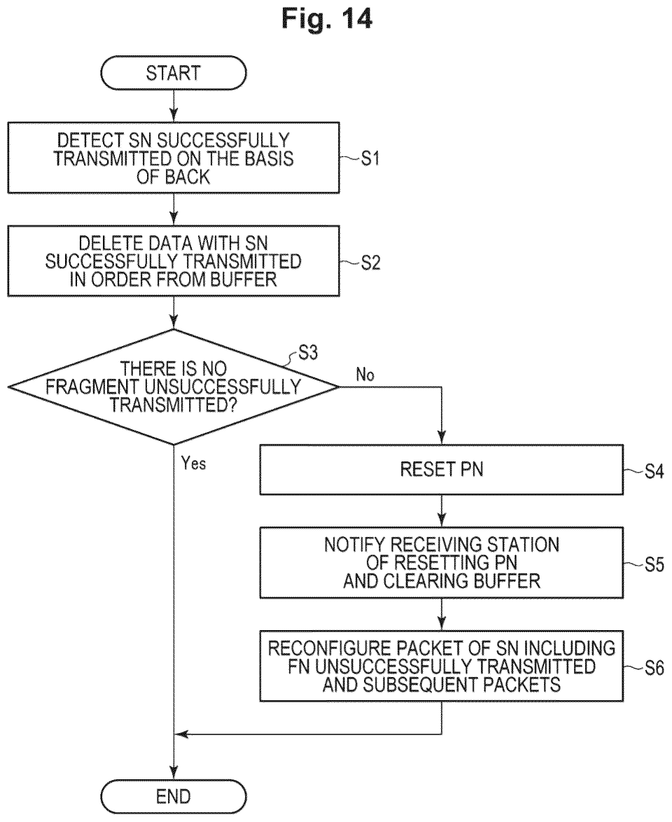

Next, operation of the wireless system 1 according to the embodiment will be described. FIG. 14 is a flowchart illustrating operation of the retransmission control unit 3231 in the transmitting station. Prior to the operation of FIG. 14, it is assumed that the transmitting station has transmitted data to the receiving station and then has received a BACK from the receiving station as a response to a BAR further transmitted to the receiving station.

In step S1, the retransmission control unit 3231 detects a sequence number successfully transmitted on the basis of the BACK. The sequence number successfully transmitted is a sequence number whose reception status is “1” for all corresponding fragment numbers.

In step S2, the retransmission control unit 3231 instructs the SN allocation unit 3212 to delete A-MSDUS with the sequence numbers successfully transmitted in order from the buffer. That is, even if there is a sequence number whose reception status is “1” for all fragment numbers, when transmission has failed for the previous sequence number, the retransmission control unit 3231 does not instruct the SN allocation unit 3212 to delete the A-MSDU with the sequence number successfully transmitted.

In step S3, the retransmission control unit 3231 determines whether or not there is no unsuccessfully transmitted sequence number. When it is determined in step S3 that there is no unsuccessfully transmitted sequence number, that is, when it is determined that transmission has succeeded for all data, the retransmission control unit 3231 ends the processing of FIG. 14. When it is determined in step S3 that there is an unsuccessfully transmitted sequence number, the retransmission control unit 3231 causes the processing to proceed to step S4.

In step S4, the retransmission control unit 3231 gives an instruction to reset the packet number to be allocated by the PN allocation unit 3214 to an initial value.

In step S5, the retransmission control unit 3231 uses the wireless signal processing unit 330 to transmit a request for resetting the packet number to the initial value and a request for clearing the buffer in the duplication detection and rearrangement unit 3224 to the receiving station.

In step S6, the retransmission control unit 3231 instructs the fragmentation unit 3213 to reconfigure the packet, that is, to redo fragmentation from the A-MSDU having the earliest sequence number among the sequence numbers including an unsuccessfully transmitted fragment number. Thereafter, the retransmission control unit 3231 ends the processing of FIG. 14. After that, as described with reference to FIG. 7, a retransmission frame that is a MAC frame for retransmission is generated, and retransmission is performed.

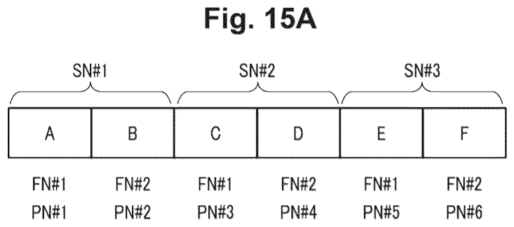

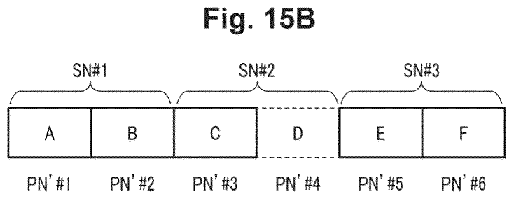

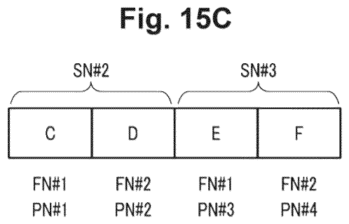

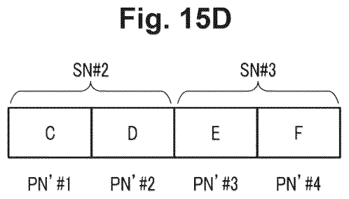

The processing of FIG. 14 will be specifically described. For example, it is assumed that a wireless signal including a wireless frame including an A-MPDU illustrated in FIG. 15A is transmitted from the transmitting station.

The A-MPDU illustrated in FIG. 15A is generated from an A-MSDU with a sequence number SN #1, an A-MSDU with a sequence number SN #2, and an A-MSDU with a sequence number SN #3. In FIG. 15A, the A-MSDU with the sequence number SN #1 is divided into two fragments (MPDUs) A and B. The A-MSDU with the sequence number SN #2 is divided into two fragments (MPDUs) C and D. The A-MSDU with the sequence number SN #3 is divided into two fragments (MPDUs) E and F. Here, in FIG. 15A, the header and the FCS are not illustrated.

As described above, the fragment number is allocated for each sequence number. Thus, fragment numbers allocated to the MPDUs A and B, fragment numbers allocated to the MPDUs C and D, and fragment numbers allocated to the MPDUs E and F each are fragment numbers FN #1 and FN #2.

On the other hand, as described above, the packet number is allocated for each encryption. Thus, packet numbers allocated to the MPDUs A and B are PN #1 and PN #2, packet numbers allocated to the MPDUs C and D are PN #3 and PN #4, and packet numbers allocated to the MPDUs E and F are PN #5 and PN #6.

It is assumed that a reception status in a case where a wireless signal including the A-MPDU illustrated in FIG. 15A is transmitted is that illustrated in FIG. 15B. In the example of FIG. 15B, reception of the MPDU D with the fragment number FN #2 with the sequence number SN #2 has failed. Here, in the replay detection unit 3226 of the receiving station, a packet number to be managed corresponding to the MPDU A is PN′ #1, a packet number to be managed corresponding to the MPDU B is PN′ #2, a packet number to be managed corresponding to the MPDU C is PN′ #3, a packet number to be managed corresponding to the MPDU D is PN′ #4, a packet number to be managed corresponding to the MPDU E is PN′ #5, and a packet number to be managed corresponding to the MPDU F is PN′ #6. Actually, since the reception of the MPDU D has failed, the MPDU D is discarded in the error detection unit 3222. In this case, since the MPDUs held in the buffer is not arranged in order, the duplication detection and rearrangement unit 3224 does not output the MPDUs to the decryption unit 3225. As a result, decryption by the decryption unit 3225 and replay detection by the replay detection unit 3226 are not performed, and the packet number managed by the replay detection unit 3226 does not change from PN′ #2.

The BACK scoring unit 3223 updates the scoring board depending on an error detection result by the error detection unit 3222. In the example of FIG. 15B, the BACK scoring unit 3223 records 0 in the SN #2 and FN #2 portions of the scoring board, and records 1 in the other portions. The retransmission control unit 3232 refers to the updated scoring board in response to a BAR from the transmitting station and generates a BACK. Then, the retransmission control unit 3232 transmits the BACK to the transmitting station.

By the BACK, the retransmission control unit 3231 detects that transmission has succeeded for the sequence number SN #1 and transmission has failed for the sequence number SN #2. Thus, the retransmission control unit 3231 performs processing for retransmitting the packet of the sequence number SN #2 and subsequent packets. In the retransmission in the embodiment, reconfiguration is performed of a fragment unsuccessfully received and subsequent fragments. As described above, since the packet number is incremented for each encryption, when reconfiguration of fragments is performed as it is, the packet number is allocated to the fragments to be reconfigured in order from the packet number PN #7. This causes a mismatch between the packet number allocated to the MPDU to be reconfigured by the transmitting station and the packet number managed by the replay detection unit 3226 of the receiving station. Thus, replay detection by the replay detection unit 3226 is not performed correctly.

For this reason, the retransmission control unit 3231 gives an instruction to reset the packet number to be allocated by the PN allocation unit 3214 to an initial value. In addition, the retransmission control unit 3231 requests the receiving station to reset the packet number and clear the buffer. Thereafter, the retransmission control unit 3231 instructs the fragmentation unit 3213 to reconfigure a packet with a sequence number SN #2 and subsequent packets.

FIG. 15C illustrates an example of an A-MPDU included in a retransmission frame of a wireless signal to be retransmitted in the embodiment. The A-MPDU illustrated in FIG. 15C is generated from the A-MSDU with the sequence number SN #2 that is a sequence number including the fragment number FN #2 with the unsuccessfully transmitted sequence number SN #2 and the A-MSDU with the subsequent sequence number SN #3. Here, since the packet number to be allocated is reset, packet numbers to be allocated to the MPDUs C and D are PN #1 and PN #2, and packet numbers to be allocated to the MPDUs E and F are PN #3 and PN #4.

On the other hand, in the receiving station, the packet number is reset and the buffer is cleared in response to a request from the transmitting station. Thus, as illustrated in FIG. 15D, in the replay detection unit 3226 of the receiving station, a packet number managed corresponding to the MPDU C is PN′ #1, a packet number managed corresponding to the MPDU D is PN′ #2, a packet number managed corresponding to the MPDU E is PN′ #3, and a packet number managed corresponding to the MPDU F is PN′ #4. In this way, in the embodiment, a packet number to be allocated by the transmitting station and a packet number managed by the receiving station are synchronized. Thus, replay detection by the replay detection unit 3226 can be correctly performed.

As described above, in the embodiment, for example, in a case where reconfiguration of fragments is performed for retransmission, both the packet number to be allocated by the transmitting station and the packet number managed by the receiving station are reset. For this reason, replay detection at the time of decryption can be correctly performed. In this way, in the embodiment, for example, even in a case where fragmentation is redone for retransmission, encryption and decryption can be appropriately performed.

In addition, in the embodiment, since the packet numbers are synchronized between the transmitting station and the receiving station only by an instruction to reset the packet numbers at the time of retransmission, the configurations of the conventional encryption unit and decryption unit can be applied as they are.

Here, in the embodiment, retransmission is performed by a Go-Back-N (GBN) method in which retransmission is performed of data with a sequence number including an unsuccessfully transmitted fragment number and subsequent data. For this reason, at the time of retransmission, the receiving station is requested to reset the packet number and also to clear the buffer in the duplication detection and rearrangement unit 3224.

As a modification to this, only the unsuccessfully transmitted fragment may be reconfigured and retransmitted. In this case, the request for clearing the buffer in the duplication detection and rearrangement unit 3224 is unnecessary. For example, in the reception status as illustrated in FIG. 15B, the retransmission control unit 3231 may configure the retransmission frame only with the fragment number FN #2 with the sequence number SN #2. In this case, the duplication detection and rearrangement unit 3224 may rearrange the MPDUs including the received MPDU with the fragment number FN #2 with the sequence number SN #2 and output the MPDUs arranged in order to the decryption unit 3225. In addition, in a case where transmission has failed from a fragment in the middle of the A-MSDU with the same sequence number like the MPDU D with the sequence number SN #2, the retransmission control unit 3231 may perform reconfiguration of fragments with the unsuccessfully transmitted fragment and subsequent fragments as retransmission targets.

In addition, in the embodiment, in a case where reconfiguration of fragments is performed, the packet number is reset to an initial value. However, the packet number does not necessarily need to be reset to an initial value. That is, since it is only needs to synchronize the packet numbers between the transmitting station and the receiving station, for example, the transmitting station may transmit the packet number to be used for encryption of the fragment to the receiving station, and the receiving station may update the packet number managed by the receiving station itself by using the packet number received from the transmitting station. In this case, the packet number to be used for encryption may be the same as the packet number used for encryption of the original fragment, or may be different from the packet number used for encryption of the original fragment.

In addition, pieces of processing according to the embodiment and modification described above can also be stored as a program that can be executed by a processor that is a computer. In addition, the program can be stored in a storage medium of an external storage device such as a magnetic disk, an optical disc, or a semiconductor memory for distribution. Then, the processor reads the program stored in the storage medium of the external storage device, and the operation is controlled by the read program, whereby the above-described processing can be executed.

Note that the present invention is not limited to the embodiments described above, and various types of modifications can be made at an implementation stage without departing from the gist of the invention. In addition, the embodiments may be implemented in appropriate combination, and in that case, a combined effect can be obtained. Furthermore, the embodiments described above include various types of inventions, and various types of inventions can be extracted by a combination selected from a plurality of disclosed components. For example, even if some components are eliminated from all the components described in the embodiment, a configuration from which the components are eliminated can be extracted as an invention in a case where the problem can be solved and the advantageous effects can be obtained.

### REFERENCE SIGNS LIST

1 Wireless system
10 Access point
11, 21 CPU
12, 22 ROM
13, 23 RAM
14, 24 Wireless communication module
15 Wired communication module
20 Terminal
25 Display
26 Storage
30 Server
110, 210, 310 LLC processing unit
120, 220, 320 MAC frame processing unit
130, 230, 330 Wireless signal processing unit
240 Application execution unit
401 Receiving unit
402 AAD configuration unit
403 PN incrementing unit
404 Nonce configuration unit
405 CCMP encryption unit
406 CCMP header configuration unit
501 Receiving unit
502 AAD configuration unit
503 Nonce configuration unit
504 CCMP decryption unit
505 Header addition unit
3211 A-MSDU Aggregation unit
3212 Sequence number (SN) allocation unit
3213 Fragmentation unit
3214 Packet number (PN) allocation unit
3215 Encryption unit
3216 Header addition unit
3217 A-MPDU aggregation unit
3221 A-MPDU deaggregation unit
3222 Error detection unit
3223 BACK scoring unit
3224 Duplication detection and rearrangement unit
3225 Decryption unit
3226 Replay detection unit
3227 Defragmentation unit
3228 A-MSDU deaggregation unit
3231, 3232 Retransmission control unit

1. A transmitting station comprising a processor configured to:
divide data into fragments:
allocate a first packet number to the fragments:
encrypt the fragments on a basis of the first packet number;
transmit the fragments encrypted as a wireless signal to a receiving station; and
control retransmission of the data on a basis of a response from the receiving station,
wherein
when retransmitting the data, the processor
resets the first packet number to an initial value,
requests the receiving station to reset a second packet number managed by the receiving station to an initial value for decryption of the fragments encrypted, and
reconfigure an unsuccessfully transmitted fragment.

2. The transmitting station according to claim 1, wherein:
when retransmitting the data, the processor
further requests the receiving station to delete the unsuccessfully transmitted fragment and subsequent fragments, and
reconfigures a fragment with a sequence number including the unsuccessfully transmitted fragment, and subsequent fragments.

3. The transmitting station according to claim 1, wherein:
the processor encrypts the fragments by a Counter-mode with CBC-MAC protocol (CCMP) method.

4. A receiving station comprising a processor configured to:
detect success or failure of reception of fragments encrypted included in a wireless signal received from a transmitting station;
decrypt the fragments encrypted for which reception has succeeded on a basis of a first packet number allocated to the fragments encrypted for which the reception has succeeded:
perform replay detection of the fragments decrypted, on a basis of the first packet number, and a second packet number managed corresponding to the fragments decrypted: and
send out a response including a reception status of the fragments encrypted to the transmitting station depending on a detection result,
wherein
the processor resets the second packet number to an initial value in response to a request from the transmitting station when retransmitting data.

5. The receiving station according to claim 4, further comprising:
a buffer that holds fragments for which the reception has succeeded, wherein
the processor clears the buffer in response to a request from the transmitting station when retransmitting the data.

6. The receiving station according to claim 4, wherein;
the processor decrypts the fragments encrypted, by a Counter-mode with CBC-MAC protocol (CCMP) method.
